(19) United States
(12) Patent Application Publication
(10) Pub. No.: US 2019/0357052 A1
(43) Pub. Date: Nov. 21, 2019

(54) System and method for analyzing properties within a real time or recorded transmissions

(71) Applicant: Geoffrey E. Korrub, Austin, TX (US)

(72) Inventor: Geoffrey E. Korrub, Austin, TX (US)

(21) Appl. No.: 16/414,744

(22) Filed: May 16, 2019

Related U.S. Application Data
(60) Provisional application No. 62/672,630, filed on May 17, 2018.

(51) Int. Cl. H04W 12/12; H04W 12/08; H04W 28/10; H04W 92/10; H04L 29/06

(52) U.S. Cl. CPC H04W 12/1202; H04W 12/08; H04L 63/1416; H04W 92/10; H04W 28/10

(57) ABSTRACT

A method and system for detecting and remediating unauthorized rouge access point devices and wireless devices in wireless access networks. The system and method are capable of being operated in a standalone manor using self-discovered information about network topologies and other information vectors. The system may be operated stand alone or with other input points to enhance accuracy.

### CROSS-REFERENCE TO RELATED APPLICATION

This application claims the benefit of U.S. Provisional Application No. 62/672,630, filed May 17, 2018, incorporated herein by reference.

### BACKGROUND OF THE INVENTION

### Field of the Invention

The present invention relates generally to computer networking techniques. More particularly, the invention provides a system and method of unauthorized wireless access detection.

### Description of Related Art

Wireless networking devices namely those utilizing the Ethernet 802.11 protocol for connection share common industry standard. This standard dictate discovery, connection setup, maintenance, and finally connecting teardown.

### BRIEF SUMMARY OF THE INVENTION

It is an object of the present invention to provide a system and method for improved unauthorized wireless access device detection.

In accordance with a preferred embodiment of the present invention, a method for detecting and remediating unauthorized wireless access devices on local area computer networks comprises detecting, using a wireless network interface all relevant wireless devices and their device metadata within the geographic region, detecting, using any appropriate network interface any relevant network devices to perform detection of unauthorized access wireless devices, extracting, device metadata and or network heuristics data, cataloging all relevant device data as detected, cataloging all relevant network heuristics data as detected, identifying, devices based on network heuristics' and or device metadata, comparing, identified devices against known heuristics and or device properties to determine remediation action, and remediating identified devices to remove or limit their access.

In another embodiment of the present invention, a system for detecting and remediating unauthorized wireless access devices comprises a processor, a network communication interface, and a memory coupled to the processor, wherein the processor is configured to detect wireless devices and their metadata properties within transmission, as well as the detection of network heuristics for proposes of detecting and identifying rouge wireless device and performing remediation actions as appropriate.

Other objects and advantages will become apparent from the following descriptions, taken in connection with the accompanying drawings, wherein, by way of illustration and example, embodiments of the present invention are disclosed.

### BRIEF DESCRIPTION OF THE FIGURES

The novel features believed to be characteristic of the invention are set forth in the appended claims and claims yet to be filed. However, the invention itself, as well as preferred modes of use and further objectives and advantages thereof, will best be understood by reference to the following detailed description when read in conjunction with the accompanying Figures wherein:

FIG. 1 shows a simplified LAN architecture that supports wireless intrusion detection according to an embodiment of the invention;

FIG. 2 shows multiple methods of performing a man-in-the-middle attack;

FIG. 3 shows a rogue accesses point detection in accordance with a preferred embodiment of the present invention;

FIG. 4 shows a simplified flow of steps for making action-based decisions; and

FIG. 5 shows implementation options both as a hardware system or as a software embodiment of the present invention.

### DETAILED DESCRIPTION OF THE PREFERRED EMBODIMENTS

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner

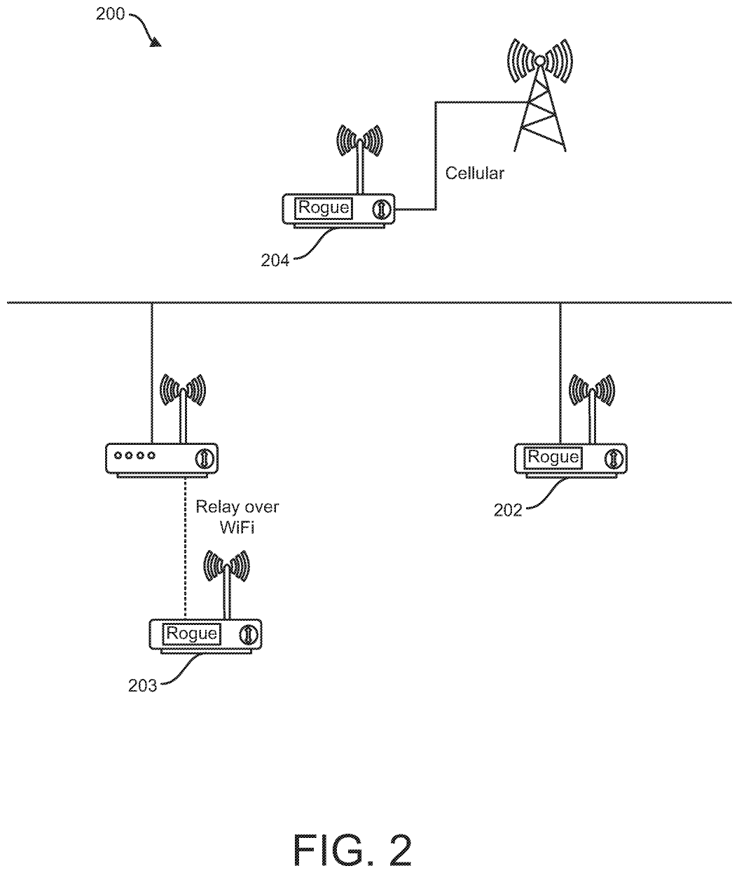

Turning to the Figures, the unauthorized wireless access detector utilizes these protocols along with additional intelligence and process steps to automate detection, and neutralization of rouge access point devices attempting to perform intercept attacks also known as man in the middle attacks where by on wireless networks rouge devices emulate the legitimate access points, see FIG. 2.

A rogue access point, 202, 203, 204, is a wireless access point that has been installed on network without explicit authorization from a local network administrator, whether added by a well-meaning employee or by a malicious attacker. These networks may be a private network such as is seen within a corporate workspace or a public network provided by an organization for patrons.

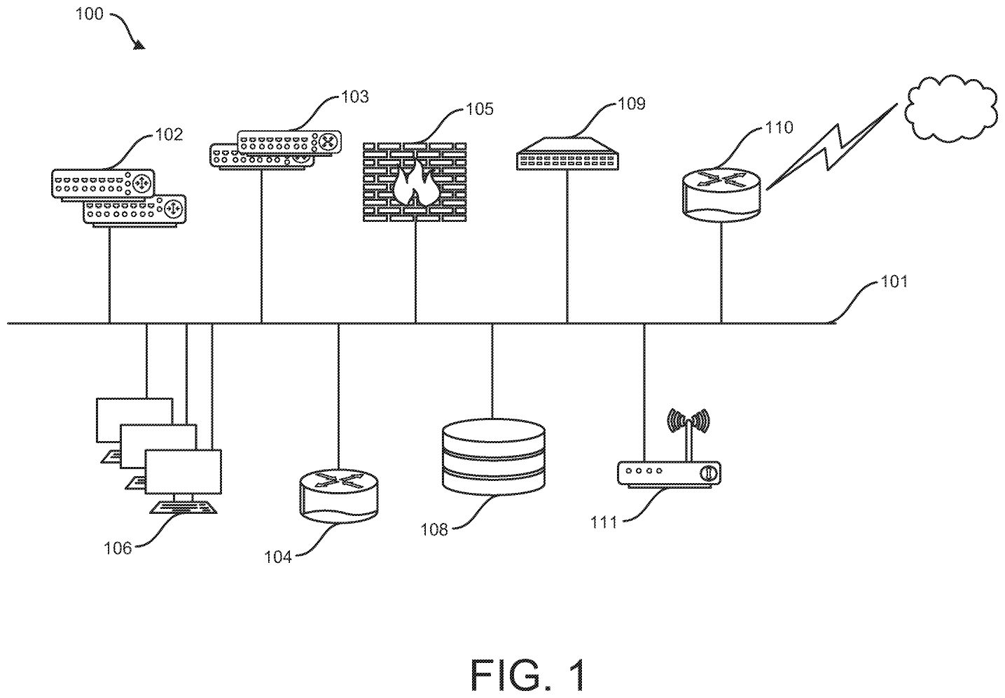

This has resulted in information security concerns for people using Wi-Fi in internet cafes and other public Wi-Fi congregation spots where there is an ever-growing prevalence of rouge access points and exploitation of patrons with the explicit intent of illegally intercepting sessions and capturing sensitive user data. This can be seen in FIG. 1, typically data devices have a level of physical protection in wired ethernet, such as PCs 106, network storage 108, network server 109 or other network based resources. Wireless devices connect with a method susceptible to hijacking and session capture, as devices communicate with an access point 111, they are vulnerable to intercept FIG. 2.

As envisioned the unauthorized wireless access detector can be installed permanently in a cafe, corporate office, or even carried as a personal protection device but in a physical for or as software on their device.

The unauthorized wireless access detector looks to provide an automatable solution that enables both the detection and neutralization of these rouge devices through any single technique or any combination of industry standard protocols, Machine Learning, Network Infrastructure insights and other detection techniques. The solution can be operated as a software solution on an individual user end point, or as a software solution added to an existing access point or as a standalone solution with as little as a single Wi-Fi interface.

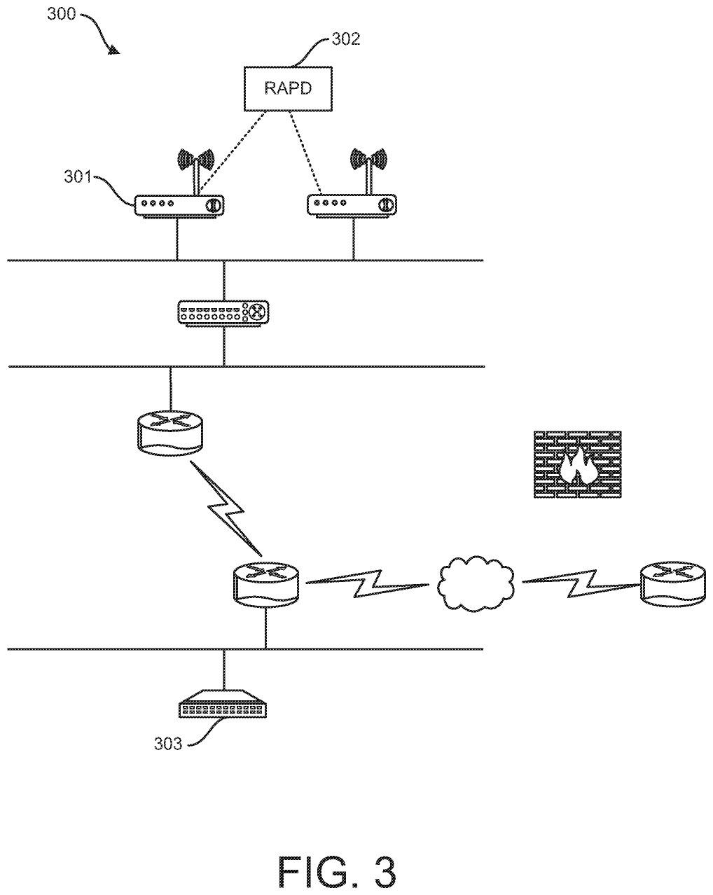

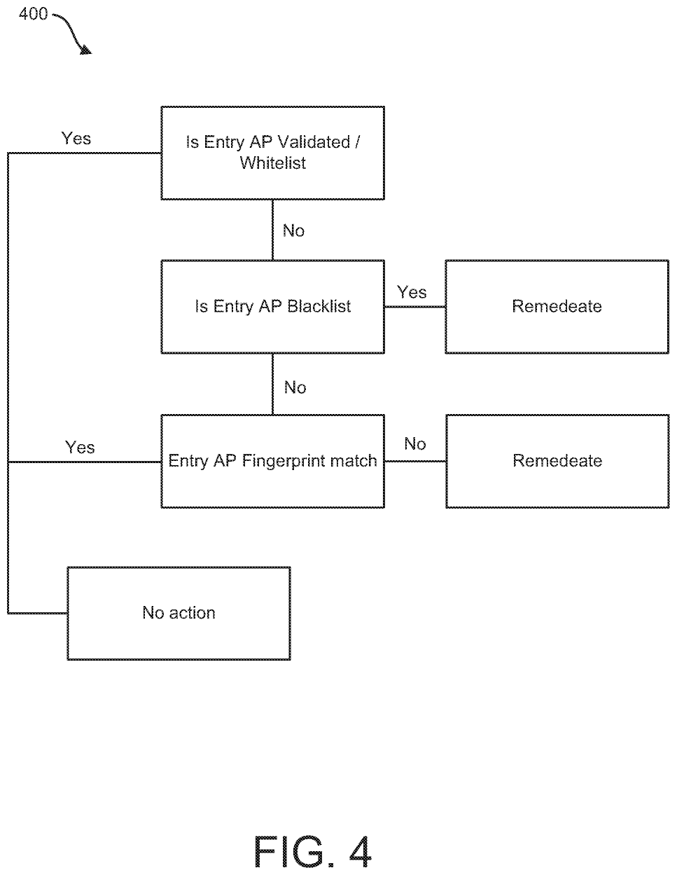

In the preferred embodiment the unauthorized wireless access detector looks to first understanding the environment FIG. 3, that it is protecting. The device builds a catalog of network heuristics and identifying metadata from each network device it is connected 301, and or devices along a point in the network 303, and or other identifying method based on environmental heuristics and or metadata. The process for building this catalog of data may be pre-programed, automated, manual or a hybrid or any of these. Once the catalog is built the unauthorized wireless access detector will protect against Rouge Access Points by using the Access Point and SSID that it is protecting to as it's known good its local database FIG. 4 of legitimate SSID and\or MAC combinations for an access point.

In another instance of the unauthorized wireless access detector a local database of SSIDs and good authorized Access Point mac addresses is stored on the unauthorized wireless access detector through use programming either directly through a user interface such as a webpage, an app.

In yet another instantiation of the solution the unauthorized wireless access detector installed as software on the access point directly in this method the unauthorized wireless access detector software would operate as above in detecting rouge access points through but may also self-protect through network heuristics and metadata. This self-protect technique is similar to a traditional firewall or intrusion detection system today but operating on network heuristics and metadata.

In yet another instantiation of the solution the unauthorized wireless access detector is programed through an external system, this may include a protocol delivery of data, a pull of data and or a programmatic connection to a wireless access point(s) and or wireless controller.

In yet another instance the unit may self-program using machine learning to see what access points are legitimate versus rouge. This learning may use a combination of fully unique fields, semi-unique fields, Geo information, time and or any other types of meta and session data available. In addition, any number of external data sources may be called upon to support machine learning and decision engine.

In addition, the unauthorized wireless access detector may build a shared configuration database, shared peer to peer and or, hosted on a local server and or on the cloud. This configuration database will synchronize as needed or on a schedule.

Once configured the unauthorized wireless access detector may be gathering information about Rouge access points and/or devices that have been diverted to them. When a rouge device is detected actions are executed based on a ruleset. These actions will include issuance of a De-Author similar session disruption technique to any devices attempting to communicate with the rouge access point and or any number of additional system alerts.

The unauthorized wireless access detector will collect its needed information based on its instantiation. In a software only mode, the unauthorized wireless access detector may be added to an existing hardware platform with capabilities of capturing Wi-Fi data as part of its native functions. An example of this may be a next generation access point with unauthorized wireless access detector as a feature.

The most basic instantiation of the unauthorized wireless access detector is a computing device with a single network interface shared by all functions. This manifestation will have varying capabilities and may gather information about rouge access points based on third party network nodes such as another vendor's access point. This instantiation may also utilize the third party devices to relay traffic on its behalf. Or it may perform these actions on its own.

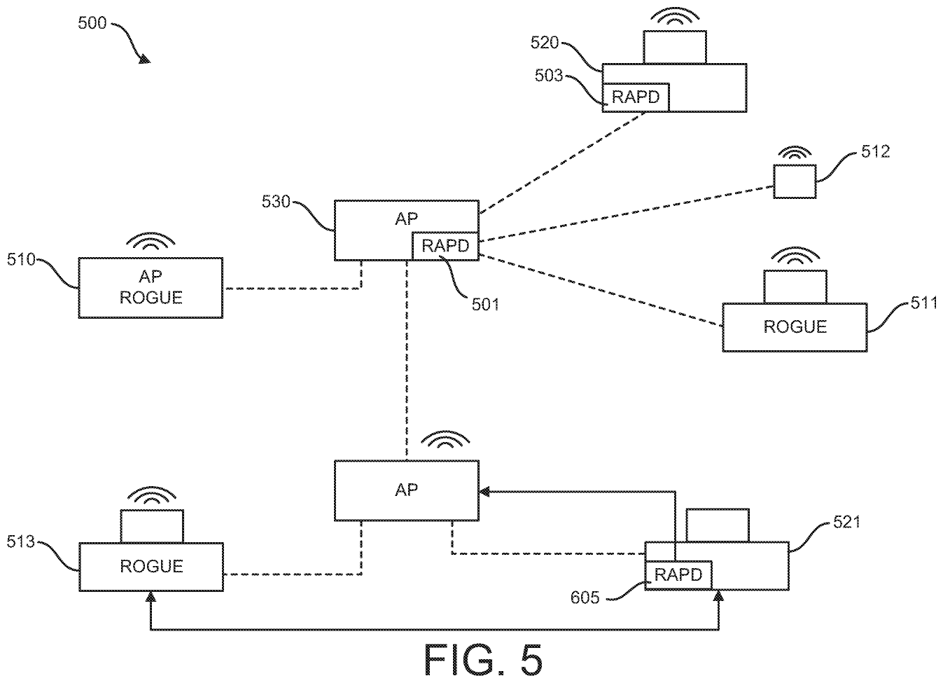

In a software implemented embodiment, see FIG. 5, the unauthorized wireless access detector is implemented as software on an existing device, 501, 503, 505, and the solution may have any number of network interfaces with network or internet connectivity. This proposed embodiment utilizes the same network heuristics and metadata analysis methods mentioned in previous embodiments for detection and neutralization for rouge wireless devices of all types, 510, 511, 512, 513. In this software implementation, the unauthorized wireless access detector may remediate through the methods previously described and or act locally on traffic destined to terminate directly the device, 520, 521, or transiting through the device, 530.

While the invention has been described in connection with preferred embodiments, it is not intended to limit the scope of the invention to the particular forms set forth, but on the contrary, it is intended to cover such alternatives, modifications, and equivalents as may be included within the spirit and scope of the invention as defined by the appended claims, and claims that may issue.

What is claimed:

1. A method for detecting and remediating unauthorized wireless access devices on local area computer networks, the method comprising:
detecting, using a wireless network interface all relevant wireless devices and their device metadata within the geographic region;
detecting, using any appropriate network interface any relevant network devices to perform detection of unauthorized access wireless devices;
extracting, device metadata and or network heuristics data;
cataloging, all relevant device data as detected;
cataloging all relevant network heuristics data as detected;
identifying, devices based on network heuristics' and or device metadata;
comparing, identified devices against known heuristics and or device properties to determine remediation action; and
remediating identified devices to remove or limit their access.

2. The method as claimed in claim 1 wherein the detected wireless devices have no predetermined type or protocol.

3. The method as claimed in claim 1 wherein the detected wireless devices may be of any type.

4. The method as claimed in claim 1 wherein the detected network devices may be in any geographic location.

5. The method as claimed in claim 1 wherein the network devices may be of any type.

6. The method as claimed in claim 1 wherein the extracted metadata may include any combination of device MAC address, IP address, MLME settings, and or other imbedded data that may be used to narrow and identification of a device.

7. The method as claimed in claim 6 wherein the imbedded data may be vendor generic, or specifically imbedded as a user and or device identifier.

8. The method as claimed in claim 1 wherein the extracted network heuristics data may include any combination of, network layer addressing, network path tracing, and or time through a network.

9. The method as claimed in claim 8 wherein the network layer addressing may differ to include any addressing relevant to the protocol in use at any layer of the OSI model.

10. The method as claimed in claim 8 wherein the network path tracing may be to a single endpoint or multiple endpoints.

11. The method as claimed in claim 10 where the endpoints may be installed without limitation for type or reusability.

12. The method as claimed in claim 8 wherein the time through the network may be measured to any level of accuracy as needed.

13. The method as claimed in claim 1 wherein the cataloging of relevant data may be stored in a local database and or loaded into memory and/or uploaded off the system.

14. The method as claimed in claim 1 wherein devices and network paths are identified within the catalog later comparison.

15. The method as claimed in claim 1 wherein identified devices are compared to a ruleset of evaluation of remediation action potential.

16. The method as claimed in claim 1 wherein the remediation actions are performed against identified actionable devices.

17. The method as claimed in claim 16 where remediation may include transition of deauthorization packets,

18. The method as claimed in claim 17 where the deauthorization packets may contain forged headers and may be sent to any number or type of recipient as needed to remediate.

19. The method as claimed in claim 16 where remediation may include locally blocking access.

20. A system for detecting and remediating unauthorized wireless access devices comprising:
a processor;
a network communication interface; and
a memory coupled to the processor;
wherein the processor is configured to detect wireless devices and their metadata properties within transmission, as well as the detection of network heuristics for proposes of detecting and identifying rouge wireless device and performing remediation actions as appropriate.

21. A system as claimed in claim 20 consisting of at least one wireless interface for detecting device metadata and network heuristics to determine if a wireless device.

22. A system as claimed in claim 21 where a physical network interface may be used in conjunction with or in place of the wireless interface for detection of network heuristics.

23. A system for using metadata and network heuristics as claimed in claim 20 where the analysis of those is used at least to derive a result in the identification of rouge devices.

24. A system as claimed in claim 20 capable of performing remediation actions including but not limited to, blocking traffic or electronicky alerting other systems for enforcement.

25. A system as claimed in claim 24 where blocking of traffic my include halting traffic from a network interface on the local system, triggering an upstream system to halt traffic and or interacting with the data session.

26. A system as claimed in claim 25 where interacting with the data session may include sending session reset packets, sending deauthorization packets and or other equants.

27. A system as claimed in claim 26 where sending of packets may be sent with a forged source and or destination as needed to achieve the effect.
